(19) United States
(12) Patent Application Publication
(10) Pub. No.: US 2024/0072563 A1
(43) Pub. Date: Feb. 29, 2024

(54) ENERGY MANAGEMENT SYSTEM WITH STANDARDIZED CORE PROCESSING

(71) Applicant: ECO STOR GmbH, Kirchheim (DE)

(72) Inventors: Robert Ulrich Bürger, Eching (DE); Kevin Maximilian Busch, München (DE); Florian Zeller, München (DE); Hubert Franz Merkle, Rechtmehring (DE)

(21) Appl. No.: 18/457,117

(22) Filed: Aug. 28, 2023

Related U.S. Application Data
(60) Provisional application No. 63/402,825, filed on Aug. 31, 2022.

(51) Int. Cl. H02J 7/00; H02J 3/32; H02J 7/34

(52) U.S. Cl. CPC H02J 7/007188; H02J 3/32; H02J 7/00036; H02J 7/00712; H02J 7/34; H02J 2203/20

(57) ABSTRACT

An energy management system can include one or more memory devices. The one or more memory devices can store instructions thereon, that, when executed by one or more processors, cause the one or more processors to receive a first dataset from a first energy storage system in a first format and a second dataset from a second energy storage system in a second format. The instructions can aggregate the first dataset and the second dataset into a third dataset, the third dataset having a standard format for a core processing system to execute on. The instructions can execute the core processing system to generate a control decision to control the first energy storage system or the second energy storage system based on the third dataset.

### CROSS-REFERENCE TO RELATED PATENT APPLICATION

This application claims the benefit of, and priority to, U.S. Provisional Patent Application No. 63/402,825 filed Aug. 31, 2022, the entirety of which is incorporated by reference herein.

### BACKGROUND

The present application relates to energy management systems intended for use with stationary battery systems. In some applications, the stationary battery systems may utilize battery modules (e.g., arrays, packs, etc.) that have been repurposed from a previous use. For example, in the case of battery modules that have been utilized in electric vehicle (EV) applications, once they reach the end of their useful service life in a vehicle application (e.g., below approximately 80% of the original state of health), they can be redeployed for other energy storage applications such as providing stationary power storage for wind and solar energy systems.

An energy management system can control the storage and distribution of energy. For example, the energy management system can cause a battery to charge or discharge based on any of a variety of factors, including power demands and available charge remaining, as well as providing other features in an energy storage and distribution scheme.

It would be advantageous to provide an improved energy management system, as discussed herein.

### SUMMARY

At least one aspect is directed to a control system or an energy management system. The energy management system can include one or more memory devices storing instructions thereon. The instructions, when executed by one or more processors, can cause the one or more processors to receive a first dataset from a first energy storage system in a first format and a second dataset from a second energy storage system in a second format. The instructions can cause the one or more processors to aggregate the first dataset and the second dataset into a third dataset, the third dataset having a standard format for a core processing system to execute on. The instructions can cause the one or more processors to execute the core processing system to generate a control decision to control the first energy storage system or the second energy storage system based on the third dataset.

The instructions can cause the one or more processors to aggregate the first dataset and the second dataset to reduce the first dataset and the second dataset into the third dataset for the core processing system.

The core processing system can be configured to execute applications on the third dataset in the standard format.

The instructions can cause the one or more processors to determine, based on the control decision, a first power setpoint for the first energy storage system and a second power setpoint for the second energy storage system. The instructions can cause the one or more processors to cause the first energy storage system to operate based on the first power setpoint and the second energy storage system to operate based on the second power setpoint to fulfill the control decision.

The instructions can cause the one or more processors to determine, based on the control decision, a first power setpoint for the first energy storage system and a second power setpoint for the second energy storage system that maximizes a profit value and reduces wear on batteries of the first energy storage system and the second energy storage system. The instructions can cause the one or more processors to cause the first energy storage system to operate based on the first power setpoint and the second energy storage system to operate based on the second power setpoint to fulfill the control decision.

The instructions can cause the one or more processors to determine, based on the control decision, a first power setpoint for the first energy storage system and a second power setpoint for the second energy storage system based on at least one of a state of charge of batteries of the first energy storage system and the second energy storage system, a state of health of batteries of the first energy storage system and the second energy storage system, an apparent power of inverters of the first energy storage system and the second energy storage system, a capacity of batteries of the first energy storage system and the second energy storage system, power of the batteries of the first energy storage system and the second energy storage system, or efficiency of the batteries of the first energy storage system and the second energy storage system. The instructions can cause the one or more processors to cause the first energy storage system to operate based on the first power setpoint and the second energy storage system to operate based on the second power setpoint to fulfill the control decision.

The instructions can cause the one or more processors to execute a first energy application with the core processing system based on the dataset to generate the control decision. The instructions can cause the one or more processors to execute a second energy application with the core processing system based on the dataset to generate a second control decision. The instructions can cause the one or more processors to cause the first energy storage system or the second energy storage system to operate based on the control decision and the second control decision.

The instructions can cause the one or more processors to execute a first energy application with the core processing system based on the third dataset to generate the control decision. The instructions can cause the one or more processors to execute a second energy application with the core processing system based on the third dataset to generate a second control decision. The instructions can cause the one or more processors to aggregate the control decision and the second control decision into an aggregate control decision. The instructions can cause the one or more processors to cause the first energy storage system or the second energy storage system to operate based on the aggregate control decision.

The instructions can cause the one or more processors to execute an energy application based on the third dataset to generate a second control decision. The instructions can cause the one or more processors to aggregate the control decision and the second control decision into an aggregate control decision. The instructions can cause the one or more processors to determine, based on the aggregate control decision, a first power setpoint for the first energy storage system and a second power setpoint for the second energy storage system. The instructions can cause the one or more processors to cause the first energy storage system to operate based on the first power setpoint and the second energy storage system to operate based on the second power setpoint to fulfill the control decision.

The instructions can cause the one or more processors to aggregate a first value of the first dataset and a second value of the second dataset into a single aggregate value. The first value can represent a first characteristic of a type of the first energy storage system. The second value can represent a second characteristic of the type of the second energy storage system. The instructions can cause the one or more processors to execute the core processing system based on the single aggregate value to generate the control decision.

The instructions can cause the one or more processors to execute a first module for a first battery of the first energy storage system, the first module including a driver to interface with the first battery of the first energy storage system, the first module to aggregate first battery data of the first battery. The instructions can cause the one or more processors to execute a second module for a second battery of the first energy storage system, the second module comprising a second driver to interface with the second battery of the first energy storage system, the second module to aggregate second battery data of the second battery. The instructions can cause the one or more processors to execute a third module for the first energy storage system, the third module to aggregate the first battery data and the second battery data into the first dataset. The instructions can cause the one or more processors to execute a fourth module to aggregate the first dataset and the second dataset into the third dataset in the standard format for the core processing system to execute on.

At least one aspect is directed to a method. The method can include receiving, by one or more processing circuits, a first dataset from a first energy storage system in a first format and a second dataset from a second energy storage system in a second format. The method can include aggregating, by the one or more processing circuits, the first dataset and the second dataset into a third dataset that is in a standard format for a core processing system to execute on. The method can include executing, by the one or more processing circuits, the core processing system to generate a control decision to control the first energy storage system or the second energy storage system based on the third dataset.

The method can include aggregating, by the one or more processing circuits, the first dataset and the second dataset to reduce the first dataset and the second dataset into the third dataset.

The core processing system can be configured to execute applications on the third dataset in the standard format, wherein the applications are configured to regulate a frequency of an energy grid or reduce a load on the energy grid responsive to a request from the energy grid.

The method can include determining, by the one or more processing circuits, based on the control decision, a first power setpoint for the first energy storage system and a second power setpoint for the second energy storage system. The method can include causing, by the one or more processing circuits, the first energy storage system to operate based on the first power setpoint and the second energy storage system to operate based on the second power setpoint to fulfill the control decision.

The method can include determining, by the one or more processing circuits, based on the control decision, a first power setpoint for the first energy storage system and a second power setpoint for the second energy storage system that maximizes a profit value and reduces wear on batteries of the first energy storage system and the second energy storage system. The method can include causing, by the one or more processing circuits, the first energy storage system to operate based on the first power setpoint and the second energy storage system to operate based on the second power setpoint to fulfill the control decision.

The method can include determining, by the one or more processing circuits, based on the control decision, a first power setpoint for the first energy storage system and a second power setpoint for the second energy storage system based on at least one of a state of charge of batteries of the first energy storage system and the second energy storage system, a state of health of batteries of the first energy storage system and the second energy storage system, an apparent power of inverters of the first energy storage system and the second energy storage system, capacity of batteries of the first energy storage system and the second energy storage system, power of the batteries of the first energy storage system and the second energy storage system, or efficiency of the batteries of the first energy storage system and the second energy storage system. The method can include causing, by the one or more processing circuits, the first energy storage system to operate based on the first power setpoint and the second energy storage system to operate based on the second power setpoint to fulfill the control decision.

The method can include executing, by the one or more processing circuits, a first energy application with the core processing system based on the third dataset to generate the control decision. The method can include executing, by the one or more processing circuits, a second energy application with the core processing system based on the third dataset to generate a second control decision. The method can include causing, by the one or more processing circuits, the first energy storage system or the second energy storage system to operate based on the control decision and the second control decision.

The method can include executing, by the one or more processing circuits, an energy application based on the third dataset to generate a second control decision. The method can include aggregating, by the one or more processing circuits, the control decision and the second control decision into an aggregate control decision. The method can include determining, by the one or more processing circuits, based on the aggregate control decision, a first power setpoint for the first energy storage system and a second power setpoint for the second energy storage system. The method can include causing, by the one or more processing circuits, the first energy storage system to operate based on the first power setpoint and the second energy storage system to operate based on the second power setpoint to fulfill the control decision.

The method can include aggregating, by the one or more processing circuits, a first value of the first dataset and a second value of the second dataset into a single aggregate value. The first value can represent a first characteristic of a type of the first energy storage system. The second value can represent a second characteristic of the type of the second energy storage system. The method can include executing, by the one or more processing circuits, the core processing system based on the single aggregate value to generate the control decision.

At least one aspect is directed to one or more storage media storing instructions thereon, that, when executed by one or more processors, cause the one or more processors to receive a first dataset from a first energy storage system in a first format and a second dataset from a second energy storage system in a second format. The instructions can cause the one or more processors to aggregate the first dataset and the second dataset into a third dataset in a standard format for a core processing system to execute on. The instructions can cause the one or more processors to execute the core processing system to generate a control decision to control the first energy storage system or the second energy storage system based on the third dataset.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is an example of an energy management system that includes standardized core processing.

FIG. 2 is an example of modules and drivers that aggregate data from energy storage systems.

FIG. 3 is an example method of aggregating data of energy storage systems for a standardized core processing system to execute on.

FIG. 4 is an example computing architecture of a data processing system.

### DETAILED DESCRIPTION

Following below are more detailed descriptions of various concepts related to, and implementations of, methods, apparatuses, and systems that control energy storage systems with standardized core processing. The various concepts introduced above and discussed in greater detail below may be implemented in any of numerous ways.

An energy management system can be coupled with an energy storage system. The energy management system can be a control system that decides when, how, and in what amount for the energy storage system to store energy or provide energy. The energy management system can generate control decisions to cause the energy storage system to charge or discharge. The energy management system can be designed or programmed to integrate with one energy storage system manufactured by one manufacturer, and utilize the energy storage system for one or a limited number of use cases or energy software applications (e.g., software applications for implementing demand response, frequency regulation, etc.). The energy management system may not be flexible and may not be able to adapt to a large number of different kinds of hardware or a wide variety of energy applications.

The energy management system can be developed to operate for dedicated use cases with predefined types of hardware. The energy management system can link input data with an energy application and distribute the output data of the energy application to the hardware in a predefined or hardcoded manner. In this regard, the energy management system may not be able to adapt to new types of hardware or execute new use cases without requiring the energy management system to be redesigned or re-coded. For example, new energy storage systems may need unique interfaces or protocols, and the energy management system may need to be hard coded to handle the interfaces to the new energy storage systems. Furthermore, if the energy management system is coupled with multiple different types of energy storage systems manufactured by different manufacturers, the software or applications of the energy management system may need to be developed to specifically collect and execute on the data of the different energy storage systems.

Furthermore, to prevent energy applications from interfering with each other, the energy management system can execute one energy application at a time, or be hard coded to run a single application that combines multiple use cases or energy programs. In this regard, the energy management system can lack flexibility and may not be able to rapidly or quickly adapt to new types of energy storage systems or execute new types of energy programs. A significant amount of processing resources, memory resources, or development resources may be used to integrate new energy storage systems with the energy management system or cause the energy management system to execute new energy software programs.

To solve for these, and other technical issues, this technical solution can include standardized core processing. The energy management system can include a core processing system that provides a standardized operating or control mechanism that is flexible. The energy management system can include a core processing system that executes on a standard or predefined data format. The energy management system can aggregate datasets of various different energy storage systems in various different formats into the standard or predefined data format. The resulting aggregate dataset can be in a standardized format and include predefined variables, values, or data points that the core processing system expects.

The energy management system can be flexible in the type and number of devices that it controls. For example, battery storage systems and energy generators of all kinds can be controlled with the one energy management system. The energy management system can integrate new energy storage systems and handle manufacturer specific differences between the energy storage systems without needing re-programming for every customer version and every specific system integrated with the energy management system. The energy management system can be highly flexible and implement various use cases which can be run simultaneously. The energy management system can include an architecture and framework for a user to configure the energy management system to handle various situations, equipment types, or other differences, without hard programming the energy management system.

The datasets of the various energy storage systems can be reduced to the predefined values of the standard dataset (e.g., some values of the datasets combined, some values of the datasets discarded, etc.). For example, the energy management system can perform one or more aggregation techniques that take data points from a wide variety of manufacturer or supplier data point lists and shrink this information into a reduced set of data points that can be executed on by the core processing system or that the core processing system can perform calculations on. Because the core processing system runs on a reduced dataset, the core processing system can be a lighter weight component that can consume less memory resources or processing resources. Furthermore, the core processing system can run and determine operating decisions faster since a fewer number of individual data points or data values are input into the core processing system.

The core processor can flexibly adapt to run one or multiple different energy programs. Each energy program can be run individually or in parallel based on the standardized dataset. The energy management system can aggregate the decisions of each energy program run in the core processing system together into an aggregate decision. The energy management system can determine, based on the aggregate decision, what operating setpoints that each energy management system should operate on to fulfill the aggregate decision. The energy management system can determine how to distribute the load or power demand of the aggregate decision across the various energy storage devices. The energy management system can determine setpoints that distribute the aggregate decision based on one or multiple constraints. The constraints can be or include states of charge of the batteries of the energy storage systems. The constraints can be or include states of health of the batteries of the energy storage systems. The constraints can be or include apparent power available to inverters of the energy storage systems. The constraints can be or include hardware conditions of the energy storage systems, e.g., warnings, errors, power limitations, etc. The constraints can be or include capacity, power, efficiency or other parameters specific to different types of hardware systems.

By taking into account the various constraints, the setpoints determined for the various energy storage systems can provide smart control of energy storage systems resulting in an efficient, or a most efficient, usage of energy power plants or energy storage systems. Furthermore, by taking into account the various constraints, a techno-economically optimal or improved operation of the energy management system can be realized. Furthermore, operating based on the constraints can result in an extended lifespan of batteries or other equipment of the energy management system.

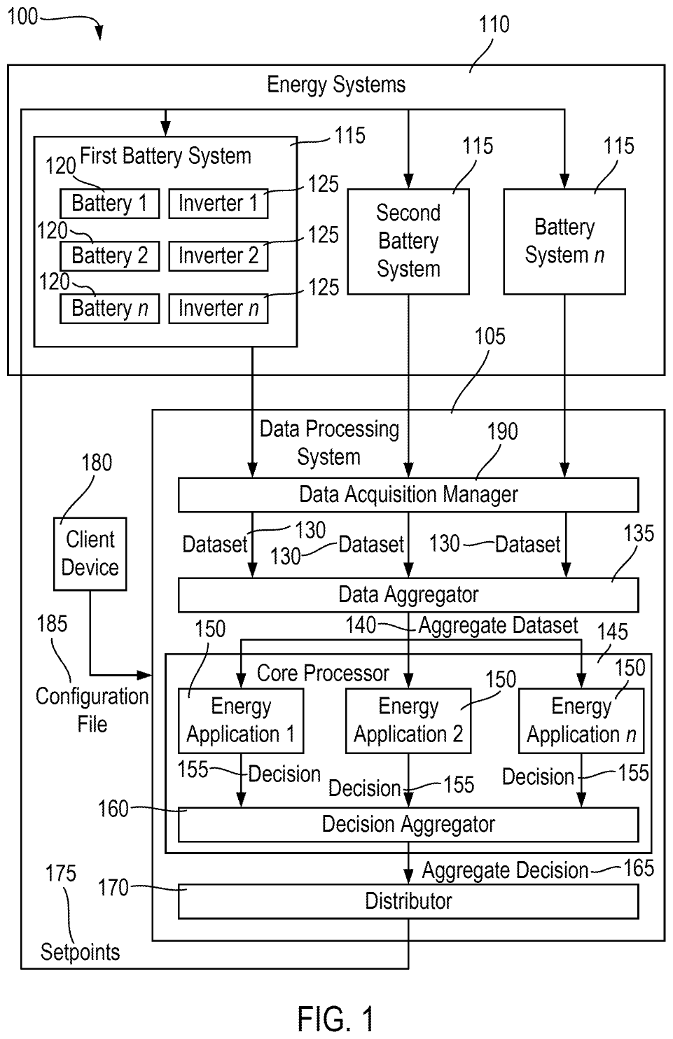

Referring now to FIG. 1, among others, an example of an energy management system 100 that includes standardized core processing is shown. The energy management system 100 can include at least one data processing system 105. The data processing system 105 can be a system that manages or controls energy systems 110. The data processing system 105 can be a control system, a controller, a server system, a desktop computer system, a microprocessor, a microcontroller, a distributed processing system, an on-premises system, an off-premises system, a control cabinet, etc. The data processing system 105 can be a back-end system of the energy management system 100.

The energy systems 110 can be or include energy storage systems that store or release energy, e.g., battery systems, hot energy storage systems, super capacitors, etc. The energy systems 110 can be plants, power plants, power generators, or systems that generate power. For example, the energy systems 110 can be or include a photovoltaic system, a wind turbine, a water turbine, a combustion engine based electric generator, etc. The energy systems 110 can include battery systems 115. The energy systems 110 can include a first battery system 115, a second battery system 115, or any number of battery systems 115. The battery systems 115 can include batteries 120 and inverters 125. The batteries 120 can be lithium ion batteries, lead-acid batteries, nickel-metal hydride batteries, solid-state batteries, lithium-sulfur batteries, or any other type of battery. The inverters 125 can electrical devices or components that convert direct current (DC) power into alternative current (AC) power. The inverters 125 can be coupled with the batteries 120, and receive DC power from the batteries 120 and provide AC power to a load or an energy grid. The loads can be a house, an electric vehicle, a school, a hospital, an appliance, etc. The energy grid can be a power or energy grid or utility.

The data processing system 105 can operate to aggregate datasets 130 from the energy systems 110, aggregate the datasets 130, execute a core processor 145 based on an aggregate dataset 140, and distribute setpoints 175 repeatedly in a cycle or cyclic operation. The cycle or cyclic operation can be initiated by a user via a client device 180. The client device 180 can be a computer through which a user can provide input to the data processing system 105. The client device 180 can be a desktop computer, a laptop computer, a smartphone, a tablet, or any other computing device or system. The client device 180 can provide at least one configuration file 185 to the data processing system 105. The user can create or edit the configuration file 185 stored by the client device 180. The user can cause, via an input to the client device 180, the client device 180 to transmit, send, or communicate the configuration file 185 to the data processing system 105.

The configuration file 185 can be a cell sheet, such as a MICROSOFT EXCEL Open Extensible Markup Language (XML) Spreadsheet (XLSX), a Comma-Separated Value (CSV) file, or an XML file. The configuration file 185 can be a text file. The configuration file 185 can be any type of structured file, data structure, database, or storage mechanism. Users can create, edit, or manipulate the configuration file 185 via graphical user interfaces, toolsets, or programs (such as a spreadsheet editor application) to define or make changes to the driver generated from the data point file. This can provide the energy management system 100 with a high degree of freedom to be used though the configuration and parameterization of the system via the configuration file 185, allowing a user to define the configuration of the energy management system 100 without directly programming the system or requiring the user to have programming skills or experience.

The configuration file 185 can be read and processed by the data processing system 105 to initialize, begin executing, or configure modules. The data processing system 105 can execute various modules that interface with the energy systems 110 that can aggregate the datasets 130 of the energy systems 110. The configuration file 185 can provide a specific configuration for each module to run. The configuration file can specify which energy application 150 for various use cases should be executed by the core processor 145. The configuration file 185 can parameterize each use case, e.g., provide parameters for each energy application 150 to run on. The energy applications 150 can be configured and executed based on the configuration file 185.

The data processing system 105 can include at least one data acquisition manager 190. The data acquisition manager 190 can be or include at least one of a module or piece of computer code that can be instantiated by the data processing system 105 to collect data from the energy systems 110. The data acquisition manager 190 can implement at least one driver that interfaces or communicates with the energy systems 110. The data acquisition manager 190 can read data points or data values from the energy systems 110 via a network or protocol, e.g., Modbus (TCP or RTU), BACnet, a local area network (LAN), a controller area network (CAN), or any other communication or network protocol. The data acquisition manager 190 can receive a dataset 130 from each energy system 110. For example, the data acquisition manager 190 can receive a first dataset 130 from a first battery system 115, a second dataset 130 from a second battery system 115, etc. The datasets 130 can be in a variety of different formats. For example, each dataset 130 can include various different data types (e.g., floats, doubles, unsigned integers, etc.) for data points of the respective energy system 110, different numbers or types of data points, different measurement units, etc. The format for each dataset 130 can be specific to the manufacturer or designer of the energy systems 110. Because the energy systems 110 can be manufactured by different manufacturers, the energy systems 110 can each provide data in a different format. For example, a first energy system 110 can provide a dataset 130 in a first format while a second energy system 110 can provide data in a second format different than the first format.

The data processing system 105 can include at least one data aggregator 135. The data aggregator 135 can be a module or component instantiated or run based on a configuration included in the configuration file 185. The data aggregator 135 can aggregate the datasets 130 into the aggregated dataset 140. The aggregated dataset 140 can be in a standard or predefined format. For example, the aggregated dataset 140 can include predefined data points or variables in a predefined data type, data measured according to specific measurement units, a predefined number of data points, etc. The core processor 145 can be designed or configured to execute based on the format of the aggregate dataset 140. In this regard, the core processor 145 can be agnostic to the underlying hardware of the energy systems 110.

The data aggregator 135 can aggregate a first dataset 130 received from a first energy system 110 with the second data 130 into the standard format of the aggregate dataset 140. The data aggregator 135 can aggregate a variety of different parameters, values, or data points into the aggregate dataset 140 based on at least one rule or rule set. The data aggregator 135 can aggregate the first dataset 130 and the second dataset 130 to reduce the first dataset 130 and the second dataset 130. The data aggregator 135 can combine data points of the first dataset 130 and the second dataset 130, such that the resulting aggregate dataset 140 is smaller in size than the first dataset 130 and the second dataset 130 together.

The data aggregator 135 can combine data points of the first dataset 130 with data points of the second dataset 130. For example, the data aggregator 135 can combine the first dataset 130 with the second dataset 130 into a third dataset 140 having a standard or standardized format for the core processor 145 to run on. The data aggregator 135 can add values of data points of the first dataset 130 and the second dataset 130. The data aggregator 135 can average values of data points of the first dataset 130 and the second dataset 130. The data aggregator 135 can add values of data points of the first dataset 130 and the second dataset 130. The data aggregator 135 can combine data points of the same data type together. For example, each of the data points that are combined can represent the same type of characteristic of the energy systems 110. The data aggregator 135 can combine a first value representing a first characteristic of a type of the first energy system 110 with a second value representing a second characteristic of the same type of the second energy system 110. The first value and the second value can be combined into a single data point, a single value, or a single value set. The single data point can be added to the aggregate dataset 140, and the core processor 145 can execute based on the single aggregate value.

For example, the aggregate dataset 140 can include a data point for total available power, a data point for total available energy, a data point for total battery capacity, a data point for average battery state of charge, a data point for average battery voltage, a data point for average battery temperature. The data aggregator 135 can combine the datasets 130 to combine data points of the same type. For example, the data aggregator 135 can combine a first battery state of charge value of the first dataset 130 with a second battery state of charge value of the second dataset 130 to form a single battery state of charge value for the aggregate dataset 140. For example, the data aggregator 135 can combine a first battery capacity of the first dataset 130 with a second battery capacity of the second dataset 130 to form a single battery capacity value for the aggregate dataset 140. Even though the energy systems 110 can have different inverters, batteries, battery capacities, ages, and power, the data aggregator 135 can combine the datasets 130 into the aggregate dataset 140.

The data processing system 105 can include at least one core processor 145. The core processor 145 can be a central processor, a core processing system, a processing unit, a processing module, or any other software or hardware component. The core processor 145 can be a virtual machine or virtual processing component. The core processor 145 can be or include central code or executables of the data processing system 105. The core processor 145 can execute based on the aggregate dataset 140 to generate decisions 155. The core processor 145 can be configured to load, run, or execute energy applications 150. The core processor 145 or the applications 150 can be designed, coded, or configured to run based on the standard or standardized format of the aggregate dataset 140. For example, the core processor 145 can be a standardized environment to remove the need for matching use cases and hardware individually. In this regard, the core processor 145 can load new applications 150 and execute the new applications 150 without requiring specific data transformations, data translations, etc. The core processor 145 can execute each of the applications 150 on the same aggregate dataset 140. Each application 150 can generate an operating or control decision 155. For example, the core processor 145 can execute a first energy application 150 based on the aggregate dataset 140 to generate a first control decision 155, and the core processor 145 can execute a second energy application 150 based on the aggregate dataset 140 to generate a second control decision 155. In this regard, new applications 150 can be added to the core processor 145 as new energy markets or use cases become available, and therefore the energy management system 100 can adapt to the new energy markets or use cases without requiring new energy systems 110, redesign of the data processing system 105, etc.

The applications 150 can be or include applications for regulating the frequency of an energy grid by consuming energy from the energy grid or providing energy to the energy grid in varying amounts (e.g., Frequency Containment Reserve (FCR)). The applications 150 can include applications for reducing or curtailing a load on the energy grid responsive to a request received from the energy grid. The applications 150 can include applications for intraday energy trading, peak shaving, or load shifting. The applications 150 can include a photovoltaic control application for controlling a photovoltaic system 110. The applications 150 can include a battery control application for controlling a battery system 115. The applications 150 can implement an application to provide reactive power. The applications 150 can be cognitive agents or agents that perform agent based calculations on the aggregate dataset 140. The agents can each include operating goals or objectives, and generate decisions 155 over time that meet the goals or objectives based on the aggregate dataset 140. The applications 150 can be manually defined applications.

Each application 150 can output a decision 155. The decisions 155 can be operational requests for operating the energy systems 110. Each decision 155 can be a decision to charge the energy systems 110 by a particular amount or for a particular length of time. The decisions 155 can be decisions to discharge energy stored by the energy systems 110 by a particular amount or for a particular length of time. The decisions 155 can be decisions to provide a particular amount of power to a load or to the power grid. Each energy application 150 can output a decision 155 for the specific energy market or control goal of the energy application 150. For example, each energy application 150 can generate a decision 155 without taking into account the constraints, goals, calculations, objectives, or decisions 155 of other energy applications 150. Each energy application 150 can generate a decision 155 that is best or suitable for the use case of the energy application 150 resulting on a power requirement for the battery systems. The data processing system 105 can cause the energy systems 110 to operate based on the decisions 155. For example, the data processing system 105 can cause the energy systems 110 to operate directly or indirectly based on the decisions 155.

The decisions 155 can be agnostic to the underlying energy systems 110. For example, instead of specifying which batteries, inverters, or other components fulfill the operation decisions 155, the decisions 155 may not reference which individual pieces of equipment fulfill the decision 155, and instead can be high level decisions for operating the energy systems 110 generally. The decisions 155 can be power charging setpoints, power discharging setpoints, state of charge goals, total energy storage goals, etc. The applications 150 can provide the decision 155 to the decision aggregator 160 or to other central code of the data processing system 105.

The data processing system 105 can include at least one decision aggregator 160. The data processing system 105 can execute the decision aggregator 160 to combine the decisions of the energy applications 150 into one or a set of aggregate decisions 165. The decision aggregator 160 can add, subtract, or average the decisions 155 to generate the aggregate decision 165. For example, the decision aggregator 160 can aggregate control decisions 155 for controlling the energy systems 110 into one aggregate control decision for controlling the energy systems 110. The decision aggregator 160 can aggregate the requests from the different applications 150, match requests working into opposite directions, and output an aggregated request or decision 165. For example, the decision aggregator 160 can aggregate a first decision 155 of the first energy application 150 and the second decision 155 of the second energy application 150 into one aggregate decision 165. The data processing system 105 can cause the energy systems 110 to operate based on the aggregate decision 165. For example, the data processing system 105 can cause the energy systems 110 to operate directly or indirectly based on the aggregate decision 165.

The data processing system 105 can include at least one distributor 170. The distributor 170 can distribute energy depending on the capabilities of the different energy systems 110 providing that every system 110 is used to the extent it can be used in a safe and reliable way, maximizing profit and reducing wear of the batteries 120. The distributor 170 can receive the aggregate decision 165 from the decision aggregator 160. The distributor 170 can generate or determine setpoints 175 from the aggregate decision 165. The distributor 170 can generate setpoints 175 that together fulfill, meet, satisfy, or implement the aggregate decision 165. Each setpoint 175 can be generated for a specific energy system 110 or battery system 115. For example, the distributor 170 can generate a first power setpoint 175 for a first energy system 110 and a second power setpoint 175 for a second energy system 110. The distributor 170 can distribute the first setpoint 175 to the first energy system 110 and the second setpoint 175 to the second energy system 110. The distributor 170 can transmit the first setpoint 175 to the first energy system 110. The distributor 170 can transmit the second setpoint 175 to the second energy system 110. The first energy system 110 can operate based on the first power setpoint 175 and the second energy storage system 110 can operate based on the second power setpoint 175. Transmitting the setpoints 175 to the energy storage systems 115 can cause the energy storage systems 115 to operate based on the setpoints 175.

For example, if the aggregate decision 165 is to discharge batteries 120 of battery systems 115 to provide an amount of power to an energy grid, a first battery 120 can operate based on a first setpoint 175 to discharge to provide a first amount of power and a second battery system 115 can operate based on a second setpoint to discharge to provide a second amount of power. The two amounts of power can equal the amount of power indicated by the aggregate decision 165. The distributor 170 can generate the two power setpoints 175 based on the aggregate decision 165. The distributor 170 can transmit the first power setpoint 175 to the first battery system 115 to cause the first battery system 115 to operate based on the first power setpoint 175. The distributor 170 can transmit the second power setpoint 175 to the second battery system 115 to cause the second battery system 115 to operate based on the second power setpoint 175.

The distributor 170 can take into account various variables, constraints, side-constraints, factors, co-factors, or other values in determining the setpoints 175 to distribute the aggregate decision 165. The variables, constraints, or other values can be included within the configuration file 185. In this regard, the configuration file 185 can parameterize the algorithm run by the distributor 170. The distributor 170 can run according to the parameters or values in the configuration file 185.

The distributor 170 can determine the setpoints 175 to spread the aggregate decision 165 across energy systems 110 to cause the energy systems 110 to collectively fulfill the aggregate decision 165. The distributor 170 can evenly spread out the aggregate decision 165 across the energy systems 110. The distributor 170 can determine the setpoints 175 for each individual energy system 110 based on a variety of constraints. The constraints can include states of charge of batteries 120 of the battery systems 115. The constraints can include states of health of batteries 120 of the battery systems 115. The constraints can include apparent power of inverters 125 of the battery systems 115. The constraints can include capacities of batteries 120 of the battery systems 115. The constraints can include power of batteries 120 of the battery systems 115. The constraints can include efficiency of the batteries 120 of the battery systems 115. The constraints can include operational hours of the batteries 120 of the battery systems 115 (e.g., a maximum or threshold amount of time that the batteries 120 can operate for). The distributor 170 can further generate the setpoints 175 based on different variable aspects, such as priority, cost, and efficiency. The distributor 170 can generate setpoint 175 that maximize revenue or increase revenue (e.g., increase revenue from participating in energy market programs, decrease overall energy costs, etc.). Furthermore, the distributor 170 can generate setpoints 175 that maximize or increase life of the batteries 120 or reduce or limit wear on the batteries 120.

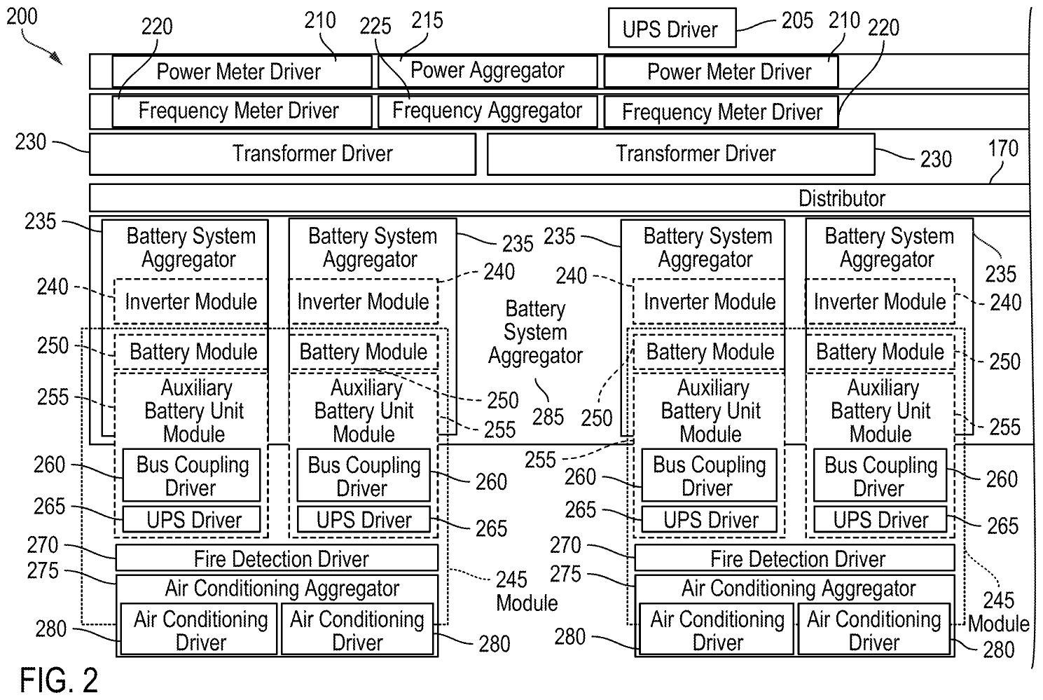

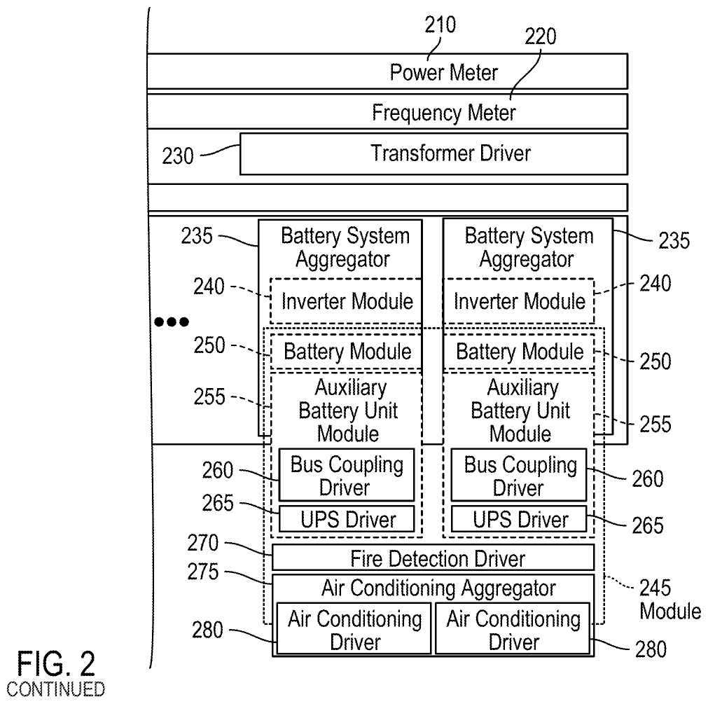

Referring now to FIG. 2, among others, a system 200 of modules and drivers that aggregate data from energy storage systems 110 is shown. The data processing system 105 can be implemented with or through the modules and drivers shown and described with reference to FIG. 2. The system 200 can include modules that aggregate information of the energy systems 110. The system 200 can include drivers that interface the modules with the physical pieces of equipment of the energy systems 110. The data processing system 105 can include multiple different types or templates of modules that can be instantiated based on the configuration file 185. Modules can be configurable and set up to run for a specific piece of equipment. For example, the data processing system 105 can instantiate each module and configure each module based on parameters of the configuration file 185. For example, the data points for a particular piece of equipment can be defined as parameters in the configuration file 185, and the data processing system 105 can instantiate a module to aggregate the values of the data points based on the configuration file 185. The modules can be general types, e.g., a module for a battery, a module for an inverter, a module for a battery system, etc. For example, the data processing system 105 can receive an indication of a type of energy system 110 in the configuration file 185, and the data processing system 105 can instantiate and run a module for the energy system 110 configured based on parameters included within the energy system 110.

For example, the configuration file 185 can indicate a battery system 115 with a particular number of batteries 120 and inverters 125. Responsive to reading the indication of the battery system 115 and the batteries 120 and inverters 125, the data processing system 105 can generate modules for the batteries 120 and inverters 125. Furthermore, the data processing system 105 can generate a module for the battery system 115. The data processing system 105 can include the modules for the batteries 120 and inverters 125 within the module for the battery system 115 responsive to identifying an indication in the configuration file 185 that the battery system 115 includes the batteries 120 and the inverters 125. In this regard, the modules for the batteries 120 and inverters 125 can aggregate the data for the respective components, and the module for the battery system 115 can aggregate the aggregated datasets of the modules.

The system 200 can include an uninterruptible power supply (UPS) driver 205 for interfacing with or controlling a physical UPS system. Furthermore, the system 200 can include a power aggregator 215 to aggregate power measurements from various physical power meters of the energy systems 110. The power aggregator 215 can include a power meter driver 210 to interface with a physical power meter of each battery system 115. The power aggregator 215 can combine, add, or average the power readings or measurements of the various battery systems 115. The system 200 can include a frequency aggregator 215 to aggregate frequency measurements from various physical frequency meters of the energy systems 110. The power aggregator 215 can include a frequency meter driver 210 to interface with a physical frequency meter of each battery system 115. The power aggregator 215 can combine or average the frequency readings or measurements of the various battery systems 115. The system 200 can include at least one transformer driver 230. The transformer driver 230 can be configured to control or interface with a physical transformer of the energy systems 110. For example, the system 200 can include a transformer driver 230 for each battery system 115, e.g., to control or interface with a transformer of each battery system 115.

The system 200 can include at least one distributor 170. The distributor 170 can be a configurable module that can decide to distribute an operating decision to the energy systems 110. The data processing system 105 can instantiate the distributor 170 based on a template, and configure the distributor 170 with information describing the characteristics or conditions of the energy systems 110 indicated in parameters or values of the configuration file 185. In this regard, the distributor 170 can be implemented and configured for the energy systems 110 coupled with the data processing system 105, without requiring the distributor 170 to be redesigned by a programmer, re-written by the programmer, etc.

The system 200 can include a battery system aggregator 285. The battery system aggregator 285 can aggregate the data of multiple energy systems 110 or battery systems 115 into the aggregate dataset 140. The battery system aggregator 285 can be a top level or high level of a hierarchy of modules. The battery system aggregator 285 can include lower level modules. For example, the battery system aggregator 285 can include a battery system aggregator 235 for each battery system 115. The battery system aggregator 235 can include lower level modules for individual components of the battery system 115 that collect information of the lower level modules, e.g., the inverter module 240, the battery module 250, etc. The battery system aggregator 235 can aggregate all of the information of the various components collected via the lower level modules into one dataset, which in turn can be aggregated with other datasets of other battery system aggregators 235 into the aggregate dataset 140 by the battery system aggregator 285. The battery system aggregator 235 can include an inverter module 240 to aggregate information from an inverter 125. The inverter module 240 can include a driver that allows the inverter module 240 to read information from or control the inverter 125. The inverter module 240 can aggregate the information received from the inverter 125, which in turn can be aggregated by the battery system aggregator 235.

The battery system aggregator 235 can include at least one battery module 250. The battery module 250 can include a driver which the battery module 250 can use to interface with the battery 120. The battery module 250 can collect and aggregate data points read from the battery modules 250. The battery system aggregator 235 can include at least one auxiliary battery unit module 255. The auxiliary battery unit module 255 can include a driver (e.g., a bus coupling driver 260 to communicate over a communication bus and a UPS driver 265 to communicate with a UPS system) which the auxiliary battery unit module 255 can use to interface with an auxiliary battery unit. The battery module 250 can collect and aggregate data points read from the battery modules 250.

The system 200 can include a module 245 that includes modules for multiple battery systems 115. For example, two or more battery system 115 can share the same air conditioning or fire detection system. In this regard, the module 245 can include a driver 270 to interface with the fire detection system. Furthermore, the module 245 can include an air conditioning aggregator 275 that aggregates data from the air conditioning system. The air conditioning aggregator 275 can include drivers 280 for communicating with different components or air conditioning systems, e.g., with a first air conditioning system of the first battery system 115 and a second air conditioning system of the second battery system 115. The data aggregated by the module 245 can be further aggregated by the battery system aggregator 285.

The modules of the system 200 can be organized in a hierarchy, where modules are included within other modules. For example, the modules of the system 200 can be nested within each other. For example, a first module can be nested within a second module, or multiple first modules nested within a second module. The hierarchy of modules can include top level modules, middle level modules, and lower or lowest level modules. The low level modules can include drivers or other software that allow the low level modules to interface with physical pieces of equipment of the energy systems 110 to read values of data points of the physical pieces of equipment or write values to the data points of the physical system (e.g., values determined by the distributor 170). The hierarchy of modules can allow for multiple levels of data collection and aggregation.

For example, the data processing system 105 can execute a first module, e.g., a first battery module 250, for a first battery 120 to interface with the first battery 120 and collect information from the first battery 120. The collected information can be data points such as battery temperature, battery voltage, battery state of charge, battery charge level, power setpoint, discharge power setpoint, charging power setpoint, etc. The first battery module 250 can include a driver that allows the first battery module 250 to communicate with the first battery 120 via a communication protocol, and read or write to the data points of the first battery module 250. The first battery module 250 can aggregate or collect the data read by the driver of the first battery module 250. The first battery module 250 can make the aggregated data of the first battery 120 available to higher level modules to access, e.g., a first battery system aggregator 235 or the battery system aggregator 285.

The data processing system 105 can execute a second module, e.g., a second battery module 250, for a second battery 120 to interface with the second battery 120 and collect information from the second battery 120. The second battery 120 can be a battery of the same battery system 115 as the first battery 120, or can be a battery of a second battery system 115 separate from the first battery system 115. The collected information can be data points such as battery temperature, battery voltage, battery state of charge, battery charge level, power setpoint, discharge power setpoint, charging power setpoint, etc. The second battery module 250 can include a driver that allows the second battery module 250 to communicate with the second battery 120 via a communication protocol, and read or write to the data points of the second battery module 250. The second battery module 250 can aggregate or collect the data read by the driver of the second battery module 250. The second battery module 250 can make the aggregated data of the second battery 120 available to higher level modules to access.

The data processing system 105 can execute a third module, e.g., the battery system aggregator 235 to aggregate the battery data of the first battery module 250 and the second battery module 250. For example, if the first battery 120 and the second battery 120 are part of the same battery system 115, the battery system aggregator 235 for the battery system 115 can aggregate the battery data of the two batteries 120. If the batteries 120 are batteries of different battery systems 115, e.g., a first battery system 115 and a second battery system 115, a first battery system aggregator 235 can aggregate the battery data of the first battery 120 collected by the first battery module 250 and a second battery system aggregator 235 can aggregate the battery data of the second battery 120 collected by the second battery module 250.

The data processing system 105 can execute a fourth module, e.g., the battery system aggregator 285. The battery system aggregator 285 can aggregate the data of the battery systems 115 and the batteries 120. For example, the battery system aggregator 285 can aggregate the data received from the battery system aggregator 235 and/or the battery module 250 into the aggregate dataset 140.

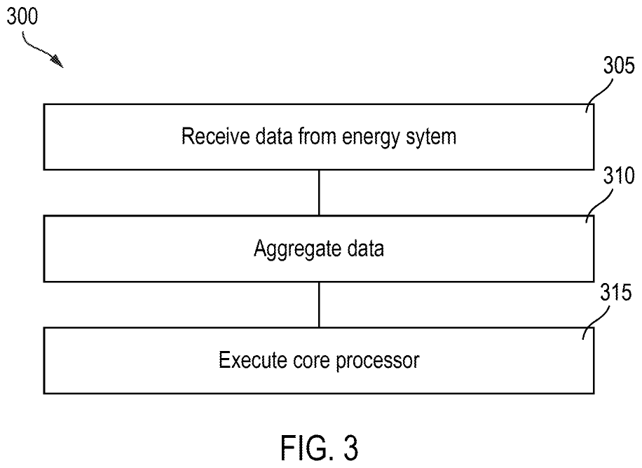

Referring now to FIG. 3, among others, a method 300 of aggregating data of energy storage systems for a standardized core processing system to execute on is shown. At least a portion of the method 300 can be performed by the energy systems 110, the battery systems 115, the batteries 120, the inverters 125, the data processing system 105, the data acquisition manager 190, the data aggregator 135, the core processor 145, the energy applications 150, the decision aggregator 160, the distributor 170, or the client device 180. The method 300 can include an ACT 305 of receiving data from an energy system. The method 300 can include an ACT 310 of aggregating data. The method 300 can include an ACT 315 of executing a core processor.

At ACT 305, the method 300 can include receiving, by the data processing system 105, data from an energy system. The data processing system 105 can receive datasets 130 of data points from the battery system 115, the batteries 120, or the inverters 125. The datasets 130 can include values of datapoints that represent measurements, calculations, operating data, faults, statuses, setpoints, or operating settings of the energy systems 110. The data processing system 105 can execute modules or a hierarchy of modules that include drivers to interface with and communicate with the energy systems 110 to receive the datasets 130. The datasets 130 can be received in a variety of different formats. For example, the energy systems 110 can be designed, manufactured, or produced by various different entities. The energy systems 110 can each include a different number or type of data points or other values.

At ACT 310, the method 300 can include aggregating, by the data processing system 105, data. The data processing system 105 can aggregate the data received at ACT 305. The data processing system 105 can aggregate the datasets 130 into an aggregate dataset 140. The aggregate dataset 140 can be a dataset of a predefined format. The format of the dataset 140 can be specific to the core processor 145, and the core processor 145 can be configured or designed to execute on the format of the aggregate dataset 140. For example, the format can define specific types of data points, specific numbers of data points, specific measurement units, specific data types (e.g., floats, integers, doubles, etc.).

At ACT 315, the method 300 can include executing, by the data processing system 105, a core processor. The data processing system 105 can execute the core processor 145 based on the aggregate dataset 140. The core processor 145 can run one or multiple different energy applications 150. The energy applications 150 can each execute based on the aggregate dataset 140. Each energy application 150 can be configured to execute on the same dataset format. Furthermore, each energy application 150 can generate a different operating or control decision 155. The decisions 155 can be high level decisions for the energy systems 110, e.g., provide various amounts of power at various times to an energy grid, or store various amounts of power at various times drawn from the energy grid or another power source. The decisions 155 can be high level and may not specify the explicit devices or hardware that implement the decision 155.

The core processor can include a decision aggregator 160 that aggregates the decisions 155 of all of the energy applications 150 into a single aggregate decision 165. The single aggregate decision 165 can be a combination of the decisions 155. The single aggregate decision 165 can be a summation of the individual decisions 155, or can be an average or weighted average of the individual decisions 155. The aggregate decision 165 can combine the various decisions 155 based on the revenue expected from each decision 165 and the wear on the batteries 120 of the energy systems 110. The aggregate decision 165 can be distributed as setpoints 175 by the distributor 170. The distributor 170 can determine setpoints 175 for each battery system 115 that fulfill, satisfy, or implement the aggregate decision 165. The distributor 170 can send each setpoint 175 to the corresponding energy system 110.

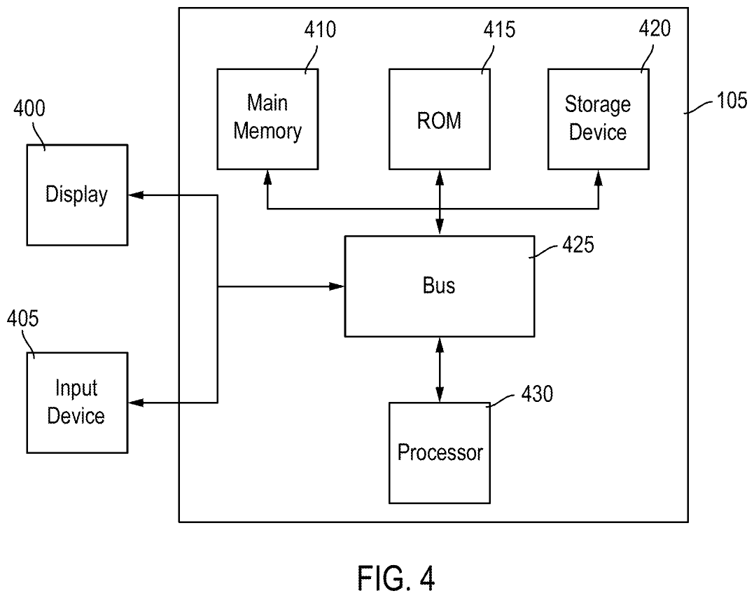

Referring now to FIG. 4, among others, an example block diagram of a data processing system 105 is shown. The data processing system 105 can include or be used to implement a data processing system or its components. The architecture described in FIG. 4 can be used to implement the computing or processing components of the energy systems 110, the battery systems 115, the batteries 120, the inverters 125, the client device 180, or the data processing system 105. The data processing system 105 can include at least one bus 425 or other communication component for communicating information and at least one processor 430 or processing circuit coupled to the bus 425 for processing information. The data processing system 105 can include one or more processors 430 or processing circuits coupled to the bus 425 for processing information. The data processing system 105 can include at least one main memory 410, such as a random access memory (RAM) or other dynamic storage device, coupled to the bus 425 for storing information, and instructions to be executed by the processor 430. The main memory 410 can be used for storing information during execution of instructions by the processor 430. The data processing system 105 can further include at least one read only memory (ROM) 415 or other static storage device coupled to the bus 425 for storing static information and instructions for the processor 430. A storage device 420, such as a solid state device, magnetic disk or optical disk, can be coupled to the bus 425 to persistently store information and instructions.

The data processing system 105 can be a remote access system or a system temporarily connected to the energy systems 110. The data processing system 105 can be coupled via the bus 425 to a display 400, such as a liquid crystal display, or active matrix display. The display 400 can display information to a user. An input device 405, such as a keyboard or voice interface can be coupled to the bus 425 for communicating information and commands to the processor 430. The input device 405 can include a touch screen of the display 400. The input device 405 can include a cursor control, such as a mouse, a trackball, or cursor direction keys, for communicating direction information and command selections to the processor 430 and for controlling cursor movement on the display 400.

The processes, systems and methods described herein can be implemented by the data processing system 105 or a display of the data processing system 105 (e.g., a touchscreen) in response to the processor 430 executing an arrangement of instructions contained or included in main memory 410. Such instructions can be read into main memory 410 from another computer-readable medium, such as the storage device 420. Execution of the arrangement of instructions contained in main memory 410 causes the data processing system 105 to perform the illustrative processes described herein. One or more processors in a multi-processing arrangement can be employed to execute the instructions contained in main memory 410. Hard-wired circuitry can be used in place of or in combination with software instructions together with the systems and methods described herein. Systems and methods described herein are not limited to any specific combination of hardware circuitry and software.

Although an example computing system has been described in FIG. 4, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components. In some implementations, the data processing system 105 is a cloud processing system that remotely interfaces with the energy systems 110.

The systems described above can provide multiple ones of any or each of those components and these components can be provided on either a standalone system or on multiple instantiations in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C #, PROLOG, Python, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices including cloud storage). The operations described in this specification can be implemented as operations performed by a data processing apparatus on data stored on one or more computer-readable storage devices or received from other sources.

The terms “computing device,” “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. ACTs, elements and features discussed in connection with one implementation are not intended to be excluded from a similar role in other implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any ACT or element being based on any information, act or element may include implementations where the act or element is based at least in part on any information, act, or element.

Any implementation disclosed herein may be combined with any other implementation or example, and references to “an implementation,” “some implementations,” “one implementation” or the like are not necessarily mutually exclusive and are intended to indicate that a particular feature, structure, or characteristic described in connection with the implementation may be included in at least one implementation or example. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

What is claimed is:

1. An energy management system, comprising:
one or more memory devices storing instructions thereon, that, when executed by one or more processors, cause the one or more processors to:
receive a first dataset from a first energy storage system in a first format and a second dataset from a second energy storage system in a second format;
aggregate the first dataset and the second dataset into a third dataset, the third dataset having a standard format for a core processing system to execute on; and
execute the core processing system to generate a control decision to control the first energy storage system or the second energy storage system based on the third dataset.

2. The energy management system of claim 1, wherein the instructions cause the one or more processors to:
aggregate the first dataset and the second dataset to reduce the first dataset and the second dataset into the third dataset for the core processing system.

3. The energy management system of claim 1, wherein:
the core processing system is configured to execute applications on the third dataset in the standard format.

4. The energy management system of claim 1, wherein the instructions cause the one or more processors to:
determine, based on the control decision, a first power setpoint for the first energy storage system and a second power setpoint for the second energy storage system; and
cause the first energy storage system to operate based on the first power setpoint and the second energy storage system to operate based on the second power setpoint to fulfill the control decision.

5. The energy management system of claim 1, wherein the instructions cause the one or more processors to:
determine, based on the control decision, a first power setpoint for the first energy storage system and a second power setpoint for the second energy storage system that maximizes a profit value and reduces wear on batteries of the first energy storage system and the second energy storage system; and
cause the first energy storage system to operate based on the first power setpoint and the second energy storage system to operate based on the second power setpoint to fulfill the control decision.

6. The energy management system of claim 1, wherein the instructions cause the one or more processors to:
determine, based on the control decision, a first power setpoint for the first energy storage system and a second power setpoint for the second energy storage system based on at least one of:
a state of charge of batteries of the first energy storage system and the second energy storage system;
a state of health of batteries of the first energy storage system and the second energy storage system;
apparent power of inverters of the first energy storage system and the second energy storage system;
capacity of batteries of the first energy storage system and the second energy storage system;
power of the batteries of the first energy storage system and the second energy storage system; or
efficiency of the batteries of the first energy storage system and the second energy storage system; and
cause the first energy storage system to operate based on the first power setpoint and the second energy storage system to operate based on the second power setpoint to fulfill the control decision.

7. The energy management system of claim 1, wherein the instructions cause the one or more processors to:
execute a first energy application with the core processing system based on the third dataset to generate the control decision;
execute a second energy application with the core processing system based on the third dataset to generate a second control decision; and
cause the first energy storage system or the second energy storage system to operate based on the control decision and the second control decision.

8. The energy management system of claim 1, wherein the instructions cause the one or more processors to:
execute a first energy application with the core processing system based on the third dataset to generate the control decision;
execute a second energy application with the core processing system based on the third dataset to generate a second control decision;
aggregate the control decision and the second control decision into an aggregate control decision; and
cause the first energy storage system or the second energy storage system to operate based on the aggregate control decision.

9. The energy management system of claim 1, wherein the instructions cause the one or more processors to:
execute an energy application based on the third dataset to generate a second control decision;
aggregate the control decision and the second control decision into an aggregate control decision;
determine, based on the aggregate control decision, a first power setpoint for the first energy storage system and a second power setpoint for the second energy storage system; and
cause the first energy storage system to operate based on the first power setpoint and the second energy storage system to operate based on the second power setpoint to fulfill the control decision.

10. The energy management system of claim 1, wherein the instructions cause the one or more processors to:
aggregate a first value of the first dataset and a second value of the second dataset into a single aggregate value, the first value representing a first characteristic of a type of the first energy storage system, and the second value representing a second characteristic of the type of the second energy storage system; and
execute the core processing system based on the single aggregate value to generate the control decision.

11. The energy management system of claim 1, wherein the instructions cause the one or more processors to:
execute a first module for a first battery of the first energy storage system, the first module comprising a driver to interface with the first battery of the first energy storage system, the first module to aggregate first battery data of the first battery;
execute a second module for a second battery of the first energy storage system, the second module comprising a second driver to interface with the second battery of the first energy storage system, the second module to aggregate second battery data of the second battery;
execute a third module for the first energy storage system, the third module to aggregate the first battery data and the second battery data into the first dataset; and
execute a fourth module to aggregate the first dataset and the second dataset into the third dataset in the standard format for the core processing system to execute on.

12. A method, comprising:
receiving, by one or more processing circuits, a first dataset from a first energy storage system in a first format and a second dataset from a second energy storage system in a second format;
aggregating, by the one or more processing circuits, the first dataset and the second dataset into a third dataset that is in a standard format for a core processing system to execute on; and
executing, by the one or more processing circuits, the core processing system to generate a control decision to control the first energy storage system or the second energy storage system based on the third dataset.

13. The method of claim 12, comprising:
aggregating, by the one or more processing circuits, the first dataset and the second dataset to reduce the first dataset and the second dataset into the third dataset.

14. The method of claim 12, wherein:
the core processing system is configured to execute applications on the third dataset in the standard format, wherein the applications are configured to regulate a frequency of an energy grid or reduce a load on the energy grid responsive to a request from the energy grid.

15. The method of claim 12, comprising:
determining, by the one or more processing circuits, based on the control decision, a first power setpoint for the first energy storage system and a second power setpoint for the second energy storage system; and
causing, by the one or more processing circuits, the first energy storage system to operate based on the first power setpoint and the second energy storage system to operate based on the second power setpoint to fulfill the control decision.

16. The method of claim 12, comprising:
determining, by the one or more processing circuits, based on the control decision, a first power setpoint for the first energy storage system and a second power setpoint for the second energy storage system that maximizes a profit value and reduces wear on batteries of the first energy storage system and the second energy storage system; and
causing, by the one or more processing circuits, the first energy storage system to operate based on the first power setpoint and the second energy storage system to operate based on the second power setpoint to fulfill the control decision.

17. The method of claim 12, comprising:
executing, by the one or more processing circuits, a first energy application with the core processing system based on the third dataset to generate the control decision;
executing, by the one or more processing circuits, a second energy application with the core processing system based on the third dataset to generate a second control decision; and
causing, by the one or more processing circuits, the first energy storage system or the second energy storage system to operate based on the control decision and the second control decision.

18. The method of claim 12, comprising:
executing, by the one or more processing circuits, an energy application based on the third dataset to generate a second control decision;
aggregating, by the one or more processing circuits, the control decision and the second control decision into an aggregate control decision;
determining, by the one or more processing circuits, based on the aggregate control decision, a first power setpoint for the first energy storage system and a second power setpoint for the second energy storage system; and
causing, by the one or more processing circuits, the first energy storage system to operate based on the first power setpoint and the second energy storage system to operate based on the second power setpoint to fulfill the control decision.

19. The method of claim 12, comprising:
aggregating, by the one or more processing circuits, a first value of the first dataset and a second value of the second dataset into a single aggregate value, the first value representing a first characteristic of a type of the first energy storage system, and the second value representing a second characteristic of the type of the second energy storage system; and
executing, by the one or more processing circuits, the core processing system based on the single aggregate value to generate the control decision.

20. One or more storage media storing instructions thereon, that, when executed by one or more processors, cause the one or more processors to:
receive a first dataset from a first energy storage system in a first format and a second data from a second energy storage system in a second format;
aggregate the first data and the second dataset into a third dataset in a standard format for a core processing system to execute on; and
execute the core processing system to generate a control decision to control the first energy storage system or the second energy storage system based on the third dataset.
